(19) United States
(12) Patent Application Publication
(10) Pub. No.: US 2025/0231722 A1
(43) Pub. Date: Jul. 17, 2025

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: YOICHIRO SHIBUYA, Saitama (JP)

(21) Appl. No.: 19/015,437

(22) Filed: Jan. 9, 2025

(30) Foreign Application Priority Data
Jan. 17, 2024 (JP) 2024-005272

(51) Int. Cl. G06F 3/12

(52) U.S. Cl. CPC G06F 3/1207; G06F 3/1259

(57) ABSTRACT

A non-transitory computer-readable storage medium storing an application program which causes an information processing apparatus to perform a control method, the control method that comprises, in a case where the application program is launched by a first method, displaying a first control item on a display of the information processing apparatus, the first control item being configured to configure a notification setting related to a state of a printing apparatus serving as an output destination of print data, wherein an operating system (OS) of the information processing apparatus acquires the state of the printing apparatus, and determines whether to issue a notification related to the acquired state of the printing apparatus based on the notification setting; and in a case where the application program is launched by a second method, displaying a second control item configured to configure a setting related to print processing of the print data.

### BACKGROUND

### Field of the Disclosure

The present disclosure relates to an information processing apparatus, a control method, and a storage medium.

### Description of the Related Art

There has been known a configuration where print instructions are issued to a printing apparatus connected to a host computer using a printer driver installed on the host computer as software for controlling the printing apparatus. An operating system (OS), or basic software, is installed on the host computer. The printer driver is configured according to specifications defined by the OS, and operates when called by the OS.

Vendors (manufacturers) who provide printing apparatuses can provide a mechanism for issuing print instructions to the printing apparatuses using the OS by providing printer drivers compliant with the OS specifications.

In recent years, Windows® has provided standard class drivers (hereinafter, also referred to as “standard drivers”) that can be used in common by printing apparatuses provided by a plurality of vendors. Such standard drivers are bundled in the OS package, and can easily be made usable by connecting a given printing apparatus to the host computer. This is highly convenient since model-specific printer drivers suitable for the printing apparatuses do not need to be separately installed.

Standard drivers are configured so that print functions can be specified based on capability information (Print Capabilities) generated based on information acquired from the connected printing apparatuses.

A user who uses a standard driver can thus specify print functions based on the capabilities of the connected printing apparatuses despite the use of the single standard driver.

Standard drivers can be associated with function extension applications (hereinafter, also referred to as “extension applications”). Extension applications can be provided by vendors providing the printing apparatuses. Extension applications can edit print function information (Print Device Capabilities) generated by a standard driver, and thereby provide functions (extended functions) that are unable to be implemented by the standard driver alone. Japanese Patent Application Laid-Open No. 2019-74906 discusses a technique for extending functions such as N-up printing by using an extension application.

During printing, various notifications are displayed regarding the state of the printing apparatus, such as a decrease in ink or toner level. There may be cases where notification display is undesirable, such as during a meeting. However, Japanese Patent Application Laid-Open No. 2019-74906 does not discuss a method for configuring desired settings on notifications about the state of the printing apparatus.

### SUMMARY

According to an aspect of the present disclosure, a non-transitory computer-readable storage medium stores an application program which causes an information processing apparatus to perform a control method that includes, in a case where the application program is launched by a first method, displaying a first control item on a display of the information processing apparatus, the first control item being configured to configure a notification setting related to a state of a printing apparatus serving as an output destination of print data, wherein an operating system (OS) of the information processing apparatus acquires the state of the printing apparatus, and determines whether to issue a notification related to the acquired state of the printing apparatus based on the notification setting configured using the first control item, and, in a case where the application program is launched by a second method, displaying a second control item configured to configure a setting related to print processing of the print data.

Further features of various embodiments will become apparent from the following description of exemplary embodiments with reference to the attached drawings.

### BRIEF DESCRIPTION OF THE DRAWINGS

FIGS. 1A and 1B are block diagrams illustrating a hardware configuration of a printing system.

FIGS. 2A and 2B are configuration diagrams of the printing system according to an exemplary embodiment.

FIG. 3 is a sequence diagram illustrating an example of print processing.

FIGS. 4A to 4C illustrate examples of screens for registering notification settings, displayed by a print setting screen extension unit and a standalone launch screen display unit.

FIG. 5 illustrates an example of a table illustrating notification settings for respective printing apparatuses.

FIG. 6 is a flowchart illustrating an example of processing by an extension application according to a first exemplary embodiment.

FIGS. 7A to 7D are flowcharts for determining statuses at which an operating system (OS) issues a toast notification.

FIG. 8 illustrates an example of the toast notification issued by the OS.

FIG. 9 is an example of a status notification screen displayed by a notification unit.

FIGS. 10A to 10C are sequence diagrams where an administrator prepares and distributes custom notification settings.

FIG. 11 is a flowchart illustrating an example of processing by an extension application according to a second exemplary embodiment.

FIG. 12 is a flowchart illustrating an example of processing by an extension application according to a third exemplary embodiment.

FIGS. 13A and 13B illustrate examples of guide screens displayed by a print data editing unit.

FIG. 14 is a flowchart illustrating an example of processing by an extension application according to a fourth exemplary embodiment.

FIG. 15 illustrates an example of a toast notification displayed by the print data editing unit.

FIG. 16 illustrates an example of a table describing correspondence between notification settings and notification setting information.

### DESCRIPTION OF THE EMBODIMENTS

Exemplary embodiments will be described in detail below with reference to the attached drawings. The following exemplary embodiments are not intended to limit the claims, and all combinations of features described in the exemplary embodiments are not necessarily essential to the solving means of every embodiment. Similar components are denoted by the same reference numerals, and a description thereof will be omitted.

### <Hardware Configuration of Printing System>

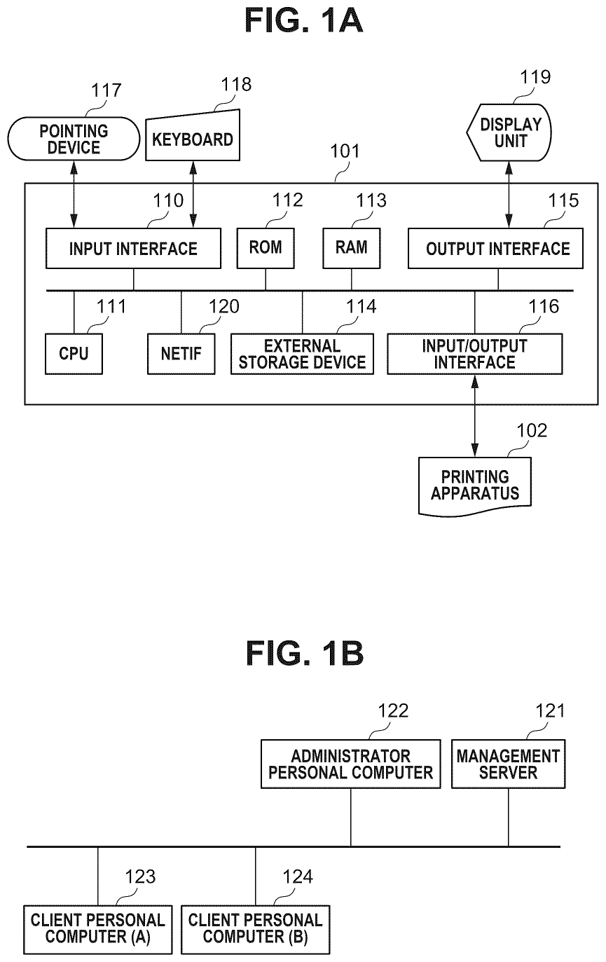

A first exemplary embodiment will be described. FIG. 1A is a block diagram illustrating a hardware configuration of a printing system. In this diagram, a host computer 101 is an example of an information processing apparatus, and includes an input interface 110, a central processing unit (CPU) 111, a read-only memory (ROM) 112, a random access memory (RAM) 113, an external storage device 114, an output interface 115, and an input/output interface 116.

Input devices such as a keyboard 118 and a pointing device 117 are connected to the input interface 110. A display device such as a display unit 119 is connected to the output interface 115. A network interface (NETIF) 120 controls data transfer with external apparatuses via a network.

The ROM 112 stores an initialization program. The external storage device 114 stores a group of application programs, an operating system (OS), print data generation software, and various other types of data. The RAM 113 is used as a work memory in executing various programs stored in the external storage device 114, whereby various programs can operate within the host computer 101.

In the present exemplary embodiment, the CPU 111 performs functions of the host computer 101 to be described below and processing related to flowcharts to be described below by the CPU 111 executing processing based on the procedures of the programs stored in the ROM 112 or the external storage device 114.

A printing apparatus 102 is connected to the host computer 101 via the input/output interface 116. While the host computer 101 and the printing apparatus 102 are separately configured here, the two may be configured as an information processing apparatus. The printing apparatus 102 will be described by using an inkjet printer that prints by discharging ink onto a sheet as an example. However, the printing apparatus 102 may perform printing using other methods (such as electrophotographic printing). The host computer 101 may be a desktop personal computer, a smartphone, or a laptop personal computer.

FIG. 1B will be described below.

### <Software-Centered Configurations of Printing System>

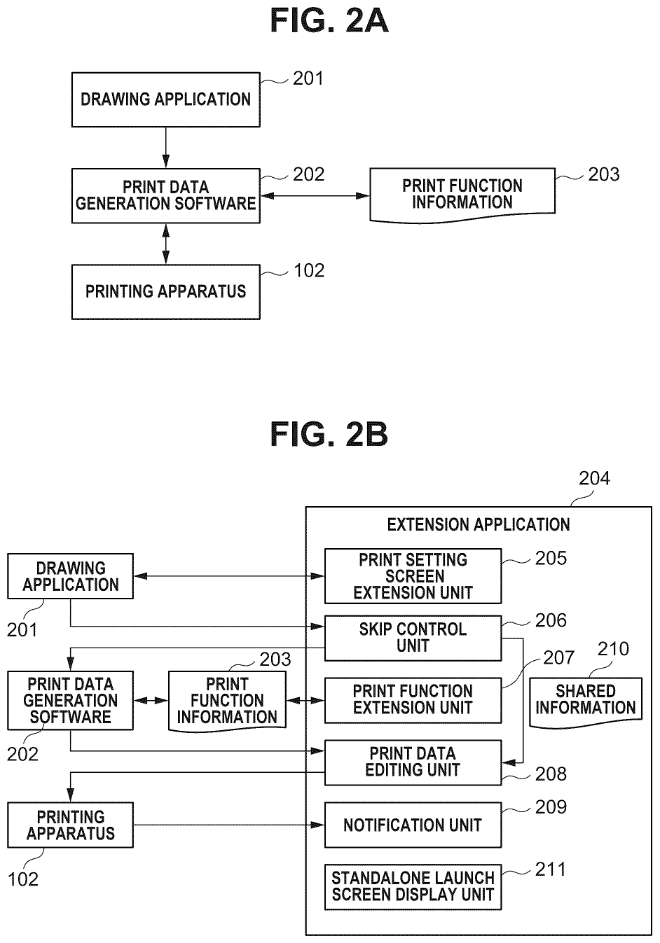

FIGS. 2A and 2B are diagrams schematically illustrating software-centered configurations of the printing system. The following description is predicated on a printing system using the host computer 101 equipped with Microsoft® Windows® 11 as the OS. FIG. 2A is a diagram illustrating a typical configuration where an extension application 204 is not associated with print data generation software 202 or the printing apparatus 102.

A drawing application 201 is software for generating content to be printed (drawing data). Examples of the drawing application 201 include a word processing application and a spreadsheet application. Receiving a print request from the user, the drawing application 201 issues print instructions to the OS. The print instructions include print setting information for instructing operation of the print data generation software 202 and the printing apparatus 102. The print setting information is also referred to as Print Ticket (PT).

To output the print setting information, the drawing application 201 can display a print setting screen provided by one of the print data generation software 202, the OS, and the drawing application 201.

The print setting screen displays setting items (hereinafter, also referred to as “control items”) representing configurable print functions and control items indicating setting values thereof based on capability information acquired from the print data generation software 202. The capability information is information configurable as print settings, and also referred to as Print Capabilities (PC).

The print data generation software 202 determines PC based on print function information 203. The print function information 203 is data indicating all configurable print functions, setting values thereof, and print functions for which exclusive relationships between setting values are described. The print function information 203 is also referred to as Print Device Capabilities (PDC).

The PDC 203 is included in a configuration file of the print data generation software 202 and placed in the external storage device 114 as an unmodifiable file. Also, the print data generation software 202 may dynamically generate the PDC 203. Specifically, the print data generation software 202 or the OS can be configured to acquire attribute data on the printing apparatus 102 from the printing apparatus 102 and generate the PDC 203 based on attribute information in the acquired attribute data.

If the PDC 203 is dynamically generated, the generated PDC 203 is editable. The attribute data on the printing apparatus 102 acquired from the printing apparatus 102 refers to a response acquired by issuing an Internet Printing Protocol (IPP) Get-Printer-Attributes operation to the printing apparatus 102. The response includes attribute information representing functions specifiable by the printing apparatus 102 (capabilities of the printing apparatus 102) and setting values related to the attribute information. This response is stored in the RAM 113.

With such a configuration, the print data generation software 202 can enable the user to specify the print functions usable by each printing apparatus 102 based on the connected printing apparatus 102. In other words, the print data generation software 202 can be configured so that the user can specify usable print functions based on connected printing apparatuses even if printing apparatuses having different functions or printing apparatuses developed by different vendors are connected.

A configuration using the IPP Class Driver or Universal Print (UP) Class Driver bundled with Windows® 10 as the print data generation software 202 will now be described.

The IPP Class Driver and the UP Class Driver are printer drivers for performing print processing based on the specifications of the standard print protocol called IPP, and bundled in the OS package. The IPP Class Driver and the UP Class Driver are not printer drivers specific to the model of the printing apparatus 102, but standard class drivers usable by a plurality of printing apparatuses in common.

The IPP Class driver is a standard driver that performs local printing, and the UP Class Driver a standard driver that performs cloud printing, based on the foregoing specifications. If cloud printing is performed using the UP Class Driver, the print data is not directly transmitted to the printing apparatus 102, but is transmitted via a cloud printing-related service and printed by the printing apparatus 102.

The IPP Class Driver and the UP Class Driver acquire the attribute information about the connected printing apparatus 102 and generate the PDC 203 based on the attribute information so that the user can specify the print functions supported by the connected printing apparatus 102.

The OS generates intermediate data (also referred to as input data) based on print instructions output from the drawing application 201, and passes the intermediate data to the print data generation software 202.

The data that the drawing application 201 outputs for printing is data of Graphic Device Interface (GDI) format or data of Extensible Markup Language (XML) Paper Specification (XPS) format.

Suppose that the IPP Class Driver is used as the print data generation software 202. If the data output by the drawing application 201 is data of GDI format, the OS converts the data of GDI format output from the drawing application 201 into data of XPS format. The OS then passes the converted data of XPS format to the print data generation software 202 as intermediate data.

If the data output by the drawing application 201 is data of XPS format, the OS passes the data of XPS format to the print data generation software 202 as intermediate data.

The intermediate data includes drawing data that is information about images to be formed on sheets and print setting information that is set by the user.

The print data generation software 202 converts the acquired intermediate data into print data interpretable by the printing apparatus 102, and transmits the print data to the printing apparatus 102. The print data includes the drawing data that is the information about the images to be formed on sheets and print setting attribute information (attribute information for specifying print settings) generated based on the print setting information set by the user. The print setting attribute information includes the attribute information representing the functions specifiable by the printing apparatus 102 (capabilities of the printing apparatus 102) and the setting values related to the attribute information.

The printing apparatus 102 performs printing on sheets based on the print data transmitted from the print data generation software 202. Here, the printing apparatus 102 forms the drawing data included in the print data on the sheets through operations based on the print setting attribute information included in the print data. The print setting attribute information includes attribute information for specifying print quality (such as image quality priority and speed priority) and two-sided printing, and setting values thereof. For example, if the print setting attribute information includes the attribute information for specifying two-sided printing, the printing apparatus 102 performs two-sided printing.

In such a manner, the print functions of the host computer 101 are provided by the print data generation software 202 and the OS. The print data generation software 202 and the OS are therefore examples of software that generates print data printable by printing apparatuses provided by a plurality of vendors.

FIG. 2B is a diagram illustrating a configuration where the extension application 204 is associated with the print data generation software 202 and the printing apparatus 102. Configurations and processing not mentioned in particular below are similar to those of FIG. 2A.

To enable generation of print data printable by printing apparatuses provided by a plurality of vendors, the usable functions of the print data generation software 202 are limited. The extension application 204 is an application provided by the vendor (manufacturer) of the printing apparatus 102 serving as the output destination of the print data. The use of the extension application 204 enables access to functions (settings related to printing and finishing) that are not usable from the print data generation software 202.

As described above, the extension application 204 is software for extending the functions of the print data generation software 202. Moreover, the extension application 204 is software not included in (bundled with) the OS in advance. The user therefore operates the host computer 101 to download the extension application 204 from a server via the Internet and install the extension application 204.

Also, the extension application 204 may be automatically installed based on the connection of the printing apparatus 102 to the host computer 101. Specifically, when the printing apparatus 102 is connected to the host computer 101, the OS acquires device identification information from the printing apparatus 102. The OS may download the extension application 204 corresponding to the acquired device identification information from the server via the Internet and install the extension application 204. In other words, the print data generation software 202 and the extension application 204 are stored in the host computer 101 as separate files.

The print data generation software 202 and the extension application 204 can be updated for upgrade, and the update processing is performed at respective different timings. In other words, the timing when the host computer 101 acquires the print data generation software 202 and the timing when the host computer 101 acquires the extension application 204 are different.

The trigger for the host computer 101 to acquire the print data generation software 202 and the trigger for the host computer 101 to acquire the extension application 204 are also different. When the extension application 204 is installed, the OS associates the extension application 204 with the print data generation software 202 and the printing apparatus 102.

The extension application 204 described in the present exemplary embodiment includes a print setting screen extension unit 205, a skip control unit 206, a print function extension unit 207, a print data editing unit 208, a notification unit 209, and a standalone launch screen display unit 211. The extension application 204 also includes shared information 210 that can be accessed from the units in common. The actual entity of the shared information 210 is a file stored in the external storage device 114 or information stored in the RAM 113.

The extension application 204 can freely write and read information to/from the shared information 210 by using an application program interface (API) provided by the OS. The shared information 210 is allocated as an area where application-specific information can be stored, and can also store information other than the attribute data on the printing apparatus 102. The shared information 210 is information different from the PDC 203 that is generated by the print data generation software 202 or the OS to specify the print functions usable by the connected printing apparatus 102.

The extension application 204 may be terminated each time the processing of one of the units ends. In such a case, the OS launches the extension application 204 each time a use request for one of the units is received. Other configurations can be employed. For example, the OS may terminate the extension application 204 when the processing of the print setting screen extension unit 205 ends, but maintain the extension application 204 running when the processing of the skip control unit 206 ends.

The extension application 204 may cancel processing of each unit halfway. If the processing is cancelled, the OS deletes the job in progress from the print queue.

When receiving a print request from the user, the drawing application 201 issues print instructions to the OS. In the present configuration, like the configuration of FIG. 2A, the drawing application 201 can display a print setting screen. In the present configuration, the drawing application 201 displays a print setting screen provided by the extension application 204. Specifically, a print setting screen provided by the print setting screen extension unit 205 included in the extension application 204 is displayed.

Whether to display the print setting screen provided by the print setting screen extension unit 205 depends on the user's operation. For example, if the drawing application 201 is a word processing application and the user presses a property setting button displayed on a print setting screen provided by the word processing application, the print setting screen provided by the print setting screen extension unit 205 is displayed.

When the drawing application 201 accepts a print request from the user and issues print instructions to the OS, the OS activates the skip control unit 206. The skip control unit 206 controls whether to skip the processing of the print data generation software 202. The skip control unit 206 is unable to acquire intermediate data or print setting information.

After the skip control processing by the skip control unit 206, the OS generates intermediate data based on the print instructions output from the drawing application 201, and passes the intermediate data to the print data generation software 202. If the skip control unit 206 does not perform the skip control, the print data generation software 202 processes the intermediate data into print data interpretable by the printing apparatus 102 and passes the print data to the print data editing unit 208.

On the other hand, if the processing of the print data generation software 202 is skipped, the intermediate data is not processed by the print data generation software 202 but passed to the print data editing unit 208. This enables the print data editing unit 208 to process the intermediate data.

Examples of the case where the processing of the print data generation software 202 is desirably skipped include when the print data editing unit 208 performs scaling processing. The intermediate data can retain data in a vector format, and does not degrade much during scaling. In a configuration where the print data generation software 202 outputs an image in a raster format, it is typically desirable to skip the processing of the print data generation software 202 and process the intermediate data by the print data editing unit 208.

The print data editing unit 208 edits the intermediate data passed from the print data generation software 202 or the print data processed by the print data generation software 202. Take N-up printing as an example of the editing content. The print data editing unit 208 changes the layout of the intermediate data or the print data based on print setting information about the N-up printing, received from the OS.

The print data editing unit 208 can display a user interface (UI) screen on the display unit 119, and can display the layout result of the intermediate data or the print data as a preview screen. The print data editing unit 208 does not transmit the print data to the printing apparatus 102 with the UI screen open. Closing the UI screen triggers the transmission processing of the print data.

After the print data editing unit 208 edits the print data, the print data is passed to the printing apparatus 102 via the OS. The printing apparatus 102 performs printing on sheets based on the accepted print data. If the processing of the print data generation software 202 is skipped by the skip control unit 206, the print data editing unit 208 may convert the received intermedia data into print data interpretable by the printing apparatus 102. To convert the intermediate data into the print data, the print data editing unit 208 may use functions provided by the OS.

The extension application 204 includes the print function extension unit 207. The print function extension unit 207 can edit the PDC 203 generated by the print data generation software 202 or the OS. The print function extension unit 207 can thereby add functions provided by the extension application 204, add functions supported by the printing apparatus 102 and not by the print data generation software 202, and add exclusive relationships between setting values of print functions.

When the extension application 204 is associated with the printing apparatus 102 and the print data generation software 202 for the first time, the OS activates the print function extension unit 207. The OS may also activate the print function extension unit 207 at other timing, such as upon startup of the OS. This enables the print function extension unit 207 to detect extended functions and add the extended functions to the PDC 203 in a case where an option apparatus (such as a finisher) is added to the printing apparatus 102 afterward and printing-related functions are extended.

The extension application 204 includes the notification unit 209. The notification unit 209 can display notifications to the user in response to the occurrence of an error in the printing apparatus 102. For example, if a paper-out error occurs in the printing apparatus 102, the print data generation software 202 detects the paper-out error, and the OS displays a message on the display unit 119 using the OS's notification function called toast notification.

If the user presses (clicks) the toast notification, the notification unit 209 of the extension application 204 is called by the OS, and a UI screen of the notification unit 209 is displayed. The UI screen of the notification unit 209 can display a detailed message regarding the paper-out error and a sheet loading method, for example.

Once the print data is transmitted to the printing apparatus 102, the extension application 204 is unable to provide screen display such as a guide linked with the print data during processing of each unit.

The extension application 204 includes the standalone launch screen display unit

211. The extension application 204 operates in association with the print data generation software 202, whereas the extension application 204 can also operate by itself. When the user issues a launch instruction for the extension application 204, the standalone launch screen display unit 211 of the extension application 204 is called, and a UI screen of the standalone launch screen display unit 211 is displayed.

The configuration of the extension application 204 for implementing the present exemplary embodiment is not limited to one that includes all the foregoing functions (units). The extension application 204 may be configured to include only some of the functions or include other functions. The extension application 204 may be referred to simply as printing software.

### <Status Notification Based on Standard Print Specifications>

Next, status notification of the printing apparatus 102 to the user in IPP will be described. IPP has a mechanism for notifying information about the state of a printing apparatus to a computer in the form of attribute values expressed by character strings. For example, information that indicates that the number of printing media (sheets) accommodated in a printing apparatus as consumables is running low is expressed by a character string “media-low-report”.

Here, the suffix “-report” indicates the significance of the status information occurring. Specifically, if the status information occurring is not so serious as to affect the print outcome, the character string “-report” is added at the end of the information.

If the status information is serious enough to potentially cause defects in the print outcome, a character string “-warning” is added at the end. For example, a case where ink serving as a consumable to be used for printing is running low is expressed by a character string “marker-supply-low-warning”.

If the status information is so serious that the printing is unable to continue, a character string “-error” is added at the end. For example, a case where the ink to be used for printing has fully run out is expressed by a character string “marker-supply-empty-error”.

For example, the printing apparatus 102 can manage information about the remaining amount of ink using the following pieces of status information separately: status information indicating that the remaining amount of ink is more than or equal to a predetermined amount, status information indicating that there still is ink but the remaining amount of ink is less than the predetermined amount, and status information indicating that the ink has run out.

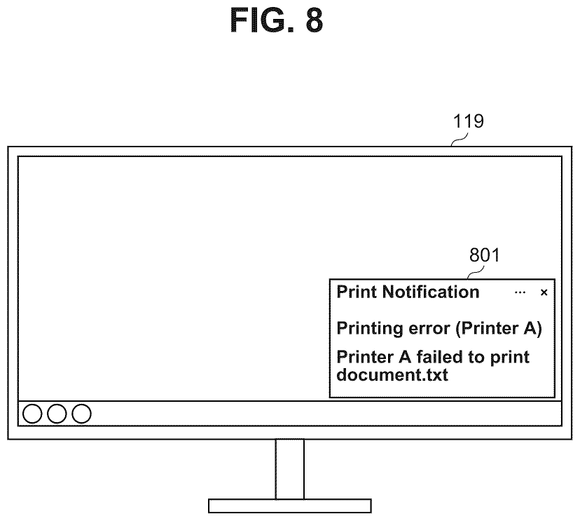

In the host computer 102, the OS displays the notified status information on the display unit 119 depending on the suffix of the status information. For example, if the suffix is “-error”, the OS issues a user notification by displaying the status information on the display unit 119 as a popup (for example, at the bottom right of the screen; see FIG. 8). If the suffix is “-report” or “-warning”, the OS does not display the status information on the display unit 119, i.e., does not issue a user notification.

In such a manner, the OS determines whether to notify the status information on the display unit 119 depending on the suffix character string. In other words, according to the standard print specifications, the suffix character string can be said to be notification instruction information for instructing whether to notify the user of the status information.

As described above, the print data generation software 202 has the function of displaying (notifying) the status information about the printing apparatus 102 on the display unit 119 depending on the significance (in the present exemplary embodiment, this function will hereinafter be referred to as a toast notification function or toast notification). The condition for the print data generation software 202 to issue the toast notification is determined by the OS in advance. It has been difficult for the user to control the condition.

In the present exemplary embodiment, as will be described below, the extension application 204 enables appropriate control of the user notification condition about the status of the printing apparatus 102 even during printing using the standard print specifications.

### <Sequence of Registration of Notification Setting and Status Information Notification>

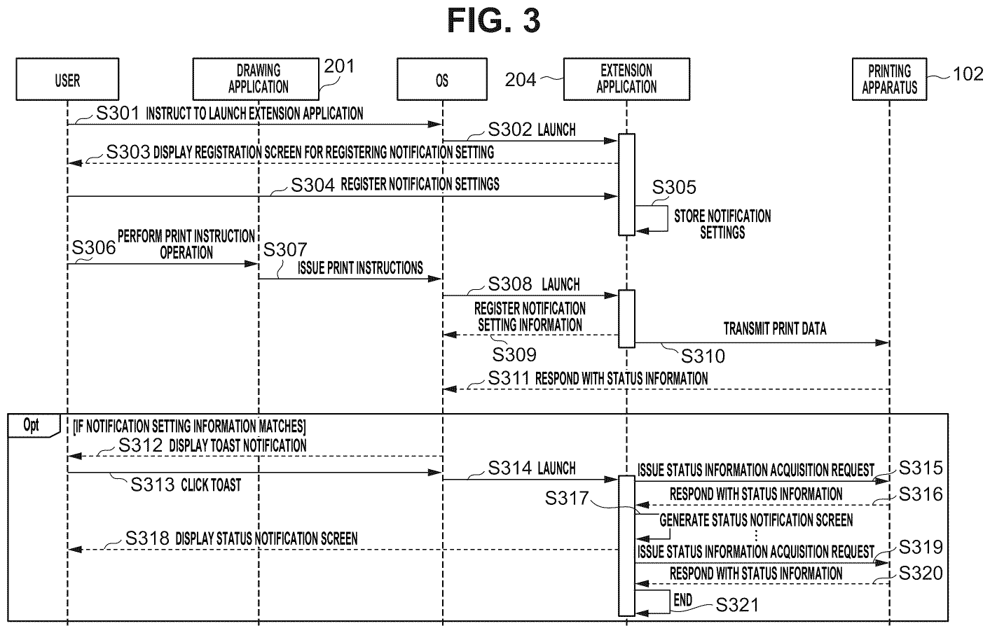

FIG. 3 is a sequence diagram illustrating an example of print processing according to the present exemplary embodiment, where the user registers and controls a desired toast notification condition as a notification setting via the extension application 204.

In step S301, the user initially instructs the OS to launch the extension application 204. In step S302, the OS launches the extension application 204 based on the launch instruction from the user. In step S303, the extension application 204 displays a registration screen for registering the notification setting indicating the user-desired toast notification condition.

For example, a print setting screen 401 to be described below may be displayed by the user pressing the property setting button displayed on the print setting screen provided by the foregoing word processing application.

Standalone launch screens 404 and 408 to be described below may be displayed by pressing an icon representing the extension application 204 on an application list screen that is displayed by pressing a button for displaying all applications on the Start menu displayed by the OS. Also, the standalone launch screens 404 and 408 to be described below may be displayed by selecting a printer management screen from a setting screen that can be activated from the Start menu and launching the extension application 204 from a detailed setting screen of the printer associated with the extension application 204.

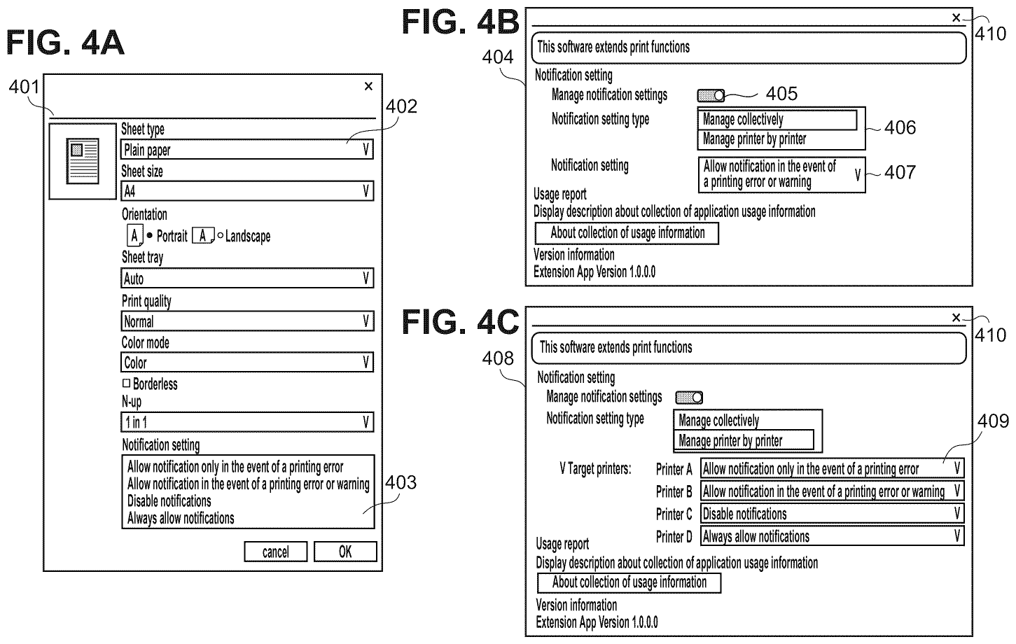

The screens that the extension application 204 displays to have the user register the notification setting will be described with reference to FIGS. 4A to 4C. FIG. 4A illustrates a print setting screen 401 that is an example of a screen displayed by the print setting screen extension unit 205.

The print setting screen 401 is a screen where the user can specify the setting values of the print functions specifiable by the print data generation software 202 based on PC that can be acquired from the OS. Examples of the setting values of the print functions include a control 402 that can set the type of sheets to be used for printing.

The print function extension unit 207 may display a status notification setting (control) 403 to the user as one of the setting values of the print functions, and have the user select a notification setting. The control 403 is a control item that enables the user to select a notification setting indicating a desired toast notification condition (an example of an acceptance unit and an acceptance step). Items such as allow notification only in the event of a printing error, allow notification in the event of a printing error or warning, disable notifications, and always allow notifications can be set. The print setting screen extension unit 205 stores the notification setting configured using the control 403 into the shared information 210.

In such a manner, enabling selection of a notification setting on the print setting screen 401 enables the user to determine the notification setting job by job so that the notification setting is controlled based on the status upon execution of each job. The standalone launch screens 404 and 408 to be described below are not displayed in executing printing, and the user can be left unaware that the notification setting is selectable. By contrast, the print setting screen 401 has the advantage of being more noticeable to the user.

The extension application 204 may register the user-desired notification setting using units other than the print setting screen extension unit 205. For example, FIGS. 4B and 4C illustrate the standalone launch screens 404 and 408, which are examples of the screen displayed by the standalone launch screen display unit 211. In the present exemplary embodiment, since the extension application 204 is intended to extend the functions of the print data generation software 202, the standalone launch screens 404 and 408 displayed by the standalone launch screen display unit 211 have bare minimum functions.

A control 405 on the standalone launch screen 404 illustrated in FIG. 4B is a control item that enables the user to switch whether to manage notification settings by himself/herself on or off. FIG. 4B illustrates the standalone launch screen 404 with the control 405 on. A control 406 is a control item from which the notification setting type can be set. Examples of the settable notification setting types include to manage notification settings collectively (collective management) and to manage notification settings by each printing apparatus (printer-by-printer management).

The standalone launch screen 404 is a screen for the case where collective management is selected from the control 406 indicating the notification setting type. A control 407 is a control item from which the notification setting can be set. For example, items such as allow notification only in the event of a printing error, allow notification in the event of a printing error or warning, disable notifications, and always allow notifications can be set as the notification setting.

In the present exemplary embodiment, the control 407 is assumed to be displayed or hidden depending on the notification setting type set from the control 406. However, the screen may be configured so that the control 407 itself is displayed but becomes unselectable depending on the notification setting type of the control 406.

The standalone launch screen 408 illustrated in FIG. 4C is a screen for the case where printer-by-printer management is selected as the notification setting type from the control 406. In the present exemplary embodiment, printer-by-printer management refers to managing notifications in units of printing apparatuses with the same product names. Also, notifications may be managed in units of generated print queues.

Controls 409 are control items from which notification settings can be configured for each of the target printing apparatuses. For example, the controls 409 can be used to set items such as allow notification only in the event of a printing error, allow notification in the event of a printing error or warning, disable notifications, and always allow notifications as the notification settings. In the present exemplary embodiment, allow notification only in the event of a printing error is set for printer A, allow notification in the event of a printing error or warning is set for printer B, disable notifications is set for printer C, and always allow notifications is set for printer D.

The standalone launch screen display unit 211 stores the notification settings configured on the standalone launch screen 404 or 408 into the shared information 210.

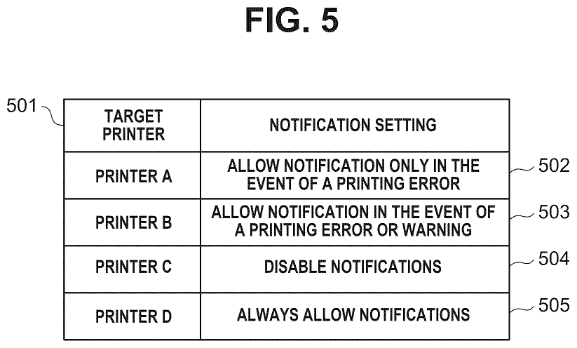

FIG. 5 illustrates a table 501, which is a table illustrating examples of the notification settings for the respective printing apparatuses, stored in the shared information 210 by the standalone launch screen display unit 211. Specifically, as illustrated in a row 502, the notification setting corresponding to the target printer A is “allow notification only in the event of a printing error”. Similarly, a row 503 indicates that the notification setting corresponding to printer B is “allow notification in the event of a printing error or warning”. As illustrated in a row 504, the notification setting corresponding to printer C is “disable notifications”. As illustrated in a row 505, the notification setting corresponding to printer D is “always allow notifications”.

In the present exemplary embodiment, the user is described to register notification settings on the screens displayed by the print setting screen extension unit 205 and the standalone launch screen display unit 211 (FIG. 4A and FIGS. 4B and 4C). The extension application 204 may have either or both the method for registering a notification setting from the screen displayed by the print setting screen extension unit 205 or/and the method for registering notification settings from the screen displayed by the standalone launch screen extension unit 211.

The extension application 204 may have the user register notification settings using other units. More specifically, the extension application 204 may have the user register notification settings using one or more of the skip control units 206, the print function extension unit 207, the print data editing unit 208, and the notification unit 209.

Return to FIG. 3 and continue description. In step S304, the user configures desired notification settings via one of the foregoing registration screens displayed by the extension application 204. In the present exemplary embodiment, suppose that the user configures the notification settings illustrated in the table 501 of FIG. 5 for the respective printing apparatuses via the standalone launch screen 408 displayed by the standalone launch screen display unit 211.

In step S305, the extension application 204 stores the notification settings in the shared information 210. Storing the notification settings in the shared information 210 enables the units included in the extension application 204 to access the shared information 210 and acquire the notification settings as appropriate, and register the notification settings in the OS. If the user registers the notification settings using the standalone launch screen display unit 211, the user ends the operation of the standalone launch screen display unit 211 by pressing an end button 410 at the top right of the standalone launch screen 408.

In step S306, the user performs a print instruction operation on the drawing application 201. In step S307, the drawing application 201 issues print instructions to the OS. In the description of this diagram, the processing of the print data generation software 202 shall be included in the processing of the OS.

In step S308, the OS launches the print data editing unit 208 of the extension application 204. The print data editing unit 208 edits the print data, transmits the print data to the printing apparatus 102, and issues an activation instruction for a UI screen as background processes. Receiving the UI activation instruction, the print data editing unit 208 activates its foreground process, and performs UI screen-related processing.

In step S309, the print data editing unit 208 registers notification setting information in the OS. The notification setting information will be described below.

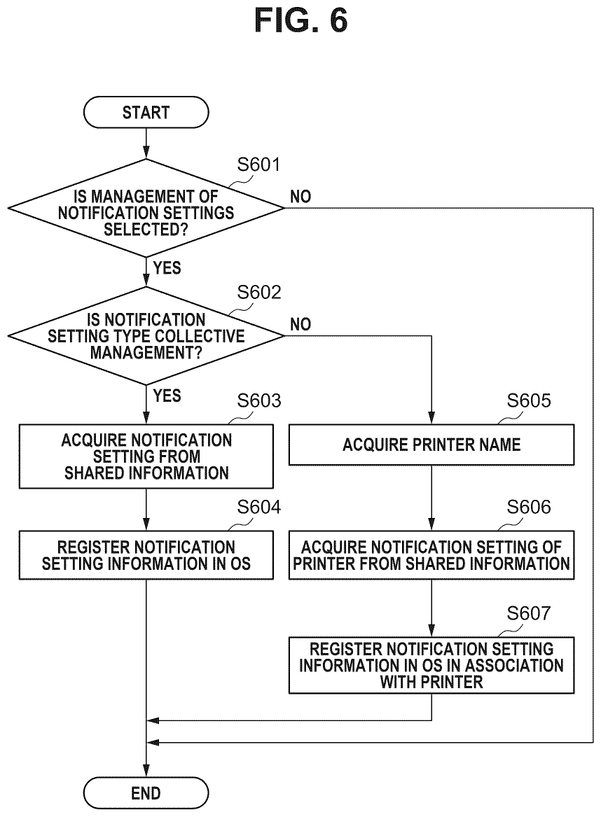

Details of the processing by the extension application 204 in step S309 will be described with reference to the flowchart of FIG. 6. In the present exemplary embodiment, the print data editing unit 208 is assumed to register the notification setting information in the OS using the notification settings registered in the shared information 210 by the standalone launch screen display unit 211.

Note that the notification setting information may be registered in the OS by other units of the extension application 204. The timing when the units of the extension application 204 register the notification setting information in the OS is not limited to that of the present exemplary embodiment, either.

For example, each unit of the extension application 204 may register the notification setting information in the OS based on the notification settings configured by the user. After the notification settings are configured by the user, the notification setting information may be registered in the OS upon activation of another unit. The notification setting information may be registered in the OS at timing when a predetermined unit of the extension application 204 is called by the drawing application 201 receiving print instructions from the user and executing the print instructions.

In step S601 of FIG. 6, the print data editing unit 208 of the extension application 204 refers to the information stored in the shared information 210 and determine whether the management of notification settings is selected. If the management of notification settings is selected (YES in step S601), the processing proceeds to step S602. If the management of notification settings is not selected (NO in step S601), the processing ends without the print data editing unit 208 registering the notification setting information in the OS.

In step S602, the print data editing unit 208 refers to the information stored in the shared information 210, and determines whether the notification setting type is collective management. If the notification setting type is collective management (YES in step S602), the processing proceeds to step S603.

In step S603, the print data editing unit 208 acquires the configured notification setting from the shared information 210. The processing proceeds to step S604. In step S604, the print data editing unit 208 registers the notification setting information in the OS based on the notification setting. In the present exemplary embodiment, the print data editing unit 208 registers the types of suffixes of the status information for the OS to issue a notification in the OS as the notification setting information based on “allow notification in the event of a printing error or warning” that is the notification setting configured on the standalone launch screen 404.

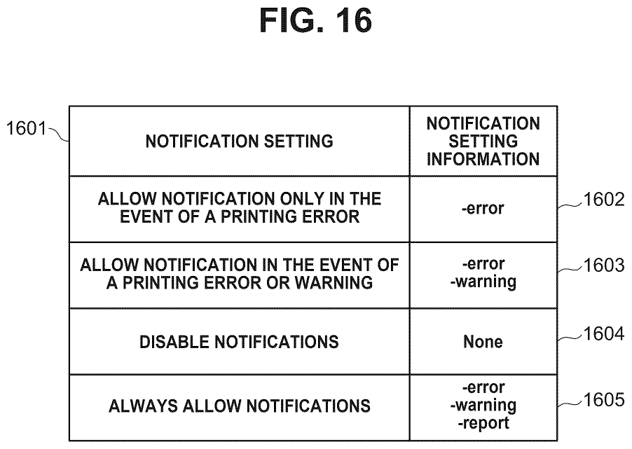

Notification settings configured by the user and the suffixes of the status information corresponding to the notification settings will be described in detail with reference to FIG. 16. FIG. 16 illustrates a table 1601 that associates the notification settings registered by the user with the notification setting information that is the suffixes indicating the status information for the OS to display a notification of to the user.

For example, in a row 1602 of the table 1601, the user-desired notification setting “allow notification in the event of a printing error” is associated with notification setting information indicating that the OS issues a notification if the suffix of the status information issued by the printing apparatus is “-error”. Similarly, in a row 1603, “allow notification in the event of a printing error or warning” is associated with notification setting information indicating that the OS issues a notification if the suffix of the status information issued by the printing apparatus is “-error” or “-warning”.

A row 1604 indicates notification setting information that there is no corresponding suffix of the status information if “disable notifications” is selected. In other words, the OS does not notify the user regardless of which type of status information is received from the printing apparatus. In a row 1605, the selection of “always allow notifications” is associated with notification setting information indicating that the OS issues a notification if the suffix is “-error”, “-warning”, or “-report”.

As described above, registering the suffixes of the status information corresponding to the user-desired notification settings into the OS as the notification setting information enables the OS to thereafter display a toast notification on the display unit 119 based on the notification setting information. As described above, in step S604, the print data editing unit 208 registers the notification setting information in the OS based on the user-desired notification setting. The processing ends.

If the notification setting type is “printer-by-printer management” (NO in step S602), the processing proceeds to step S605.

In step S605, the print data editing unit 208 acquires the printer name of the printer selected as a print instruction target. As a method for acquiring the printer name, the print data editing unit 208 may issue an IPP Get-Printer-Attributes operation to the printing apparatus 102, and acquire the printer name from the attribute information included in the acquired response.

Alternatively, the print data editing unit 208 may determine the printer name based on the hardware identifier (ID) (HWID) of the print queue associated with itself.

After the print data editing unit 208 acquires the printer name in step S605, the processing proceeds to step S606. In step S606, the print data editing unit 208 acquires the notification setting of the printer from the shared information 210.

In the present exemplary embodiment, the notification setting corresponding to the row 503 of the table 501 is assumed to be stored in the shared information 210. The print data editing unit 208 thus acquires the information indicating that the notification setting “allow notification in the event of a printing error or warning” is set for the selected printer B from the shared information 210. The processing proceeds to step S607.

In step S607, the print data editing unit 208 registers the notification setting information in the OS in association with the printer specified as the print instruction target, based on the user-desired notification setting. Specifically, the print data editing unit 208 registers two types of information in the OS.

For a first piece of information, the print data editing unit 208 registers printer B specified as the print instruction target, as the target printer to register the notification setting information. For a second piece of information, the print data editing unit 208 registers the notification setting information indicated by the row 1603 of FIG. 16 that the OS issues a notification if the suffix of the status information issued by the printing apparatus is “-error” or “-warning”.

The print data editing unit 208 may register the pieces of information in the OS simultaneously or at different timings. In the present exemplary embodiment, the print data editing unit 208 is assumed to register the notification setting information about the printing apparatus selected as the print instruction target, i.e., the target printing apparatus to transmit the print data to. However, notification setting information about other printing apparatuses may be registered.

For example, even if the print data editing unit 208 is activated with printer A selected as the print instruction target, the print data editing unit 208 may register notification setting information about a printer other than printer A indicated by the table 501 of FIG. 5 stored in the shared information 210. In step S607, the print data editing unit 208 registers the target printer and the notification setting information in the OS. The processing ends.

Return to the description of FIG. 3. After the processing of step S309 described in the foregoing flowchart of FIG. 6 ends, in step S310, the print data editing unit 208 then transmits the print data to the printing apparatus 102. The processing ends.

Receiving the print data, the printing apparatus 102 forms the drawing data included in the received print data on sheets. Now, consider a case where the ink in the printing apparatus 102 runs out and an ink-out error occurs when the printing apparatus 102 performs the print processing based on the received print data.

In step S311, the printing apparatus 102 responds to the OS with “marker-supply-empty-error” indicating the occurrence of the error. While in the present exemplary embodiment the printing apparatus 102 is described to respond to the OS with the status information, the OS may regularly monitor the state of the printing apparatus 102 and detect the transition into the error state.

Receiving the status information indicating the occurrence of the error from the printing apparatus 102 in step S311, the OS determines whether the status information matches the notification setting information registered in itself. If the status information matches the notification setting information, then in step S312, the OS displays a toast notification on the display unit 119.

In the present exemplary embodiment, the notification setting information indicating that a toast notification is issued for the suffix “-error” or “-warning”, described in the row 1603 of the table 1601, is registered in the OS based on the notification setting “allow notification in the event of a printing error or warning” in the row 503 of the table 501.

The OS therefore determines to display a toast notification from the status information with the suffix “-error”.

FIG. 8 illustrates a toast 801, which is an example of the toast notification displayed by the OS. The processing where the OS determines whether to display a toast notification on the display unit 119 will be described below. In step S313, the user clicks the toast displayed on the display unit 119. In step S314, the OS issues a launch instruction for the extension application 204. Receiving the launch instruction from the OS in step S314, the notification unit 209 of the extension application 204 starts up.

In step S315, the notification unit 209 issues a status information acquisition request to the printing apparatus 102. In step S316, the printing apparatus 102 responds to the notification unit 209 with the status information as a response to the status information acquisition request. In step S317, the notification unit 209 generates a status notification screen based on the acquired status information. In step S318, the notification unit 209 displays the generated status notification screen on the display unit 119.

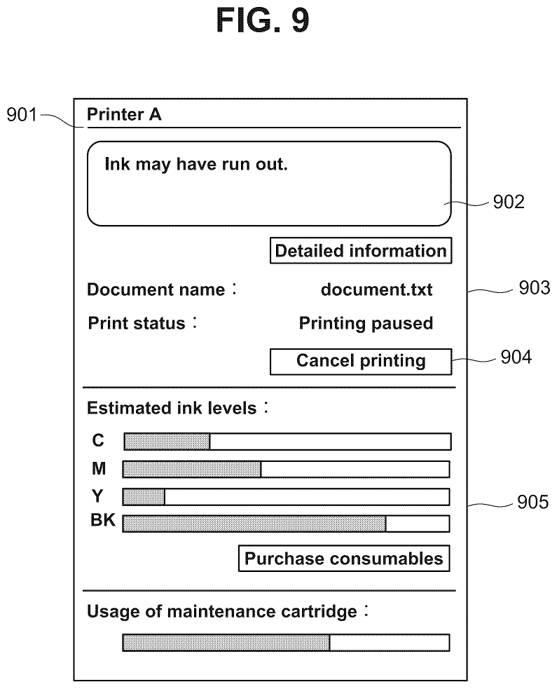

FIG. 9 is a diagram illustrating an example of the status notification screen displayed by the notification unit 209. A status notification screen 901 displayed by the notification unit 209 is a screen for notifying the user of the states of the printer and the print job based on the status information acquired from the printing apparatus 102.

A display area 902 is an area where a message indicating the state of the printing apparatus 102 is displayed based on the status information acquired from the printing apparatus 102. For example, if status information indicating “marker-supply-empty-error” is acquired from the printing apparatus 102, a message that ink may have run out is displayed as illustrated in the display area 902.

A display area 903 is an area that displays information about the print job to be monitored on the status notification screen. In the example of FIG. 9, the information indicates that a job to print “document.txt” on printer A is being monitored.

A control item 904 is a cancel printing button (cancel button). Pressing the control item 904 cancels the printing of the print job displayed in the display area 903. A display area 905 is an area that displays remaining level information about consumables used in the printing apparatus 102, such as inks and a maintenance cartridge.

Return to FIG. 3 and continue description. In step S319, the notification unit 209 of the extension application 204 regularly issues a status information acquisition request for the printing apparatus 102. In step S320, the printing apparatus 102 responds to the status information acquisition request with the status information.

In such a manner, the notification unit 209 can determine whether an error in the printing apparatus 102 is continuing or has been resolved to end the print job, by regularly requesting status information from the printing apparatus 102 and acquiring the status information. The notification unit 209 may update the status notification screen 901 based on the acquired status information and display the information to the user. If the status information is acquired from the printing apparatus 102 during display of the status notification screen 901, the display area 902 of the status notification screen 901 can be updated alone without a toast notification.

If, for example, the notification unit 209 determines that the status information acquired from the printing apparatus 102 in step S320 indicates that the processing of the print job has ended, then in step S321, the notification unit 209 ends displaying the status notification screen 901.

The notification unit 209 may continue the acquisition request and acquisition of the status information about the printing apparatus 102 and the display of the status notification screen 901 unless an explicit end instruction is accepted from the user. In such a case, for example, the notification unit 209 ends displaying the status notification screen 901 when an explicit end instruction is accepted, such as when the user presses the cancel button 904 on the status notification screen 901 to cancel the print job.

### <Determination on Display of Toast Notification by OS>

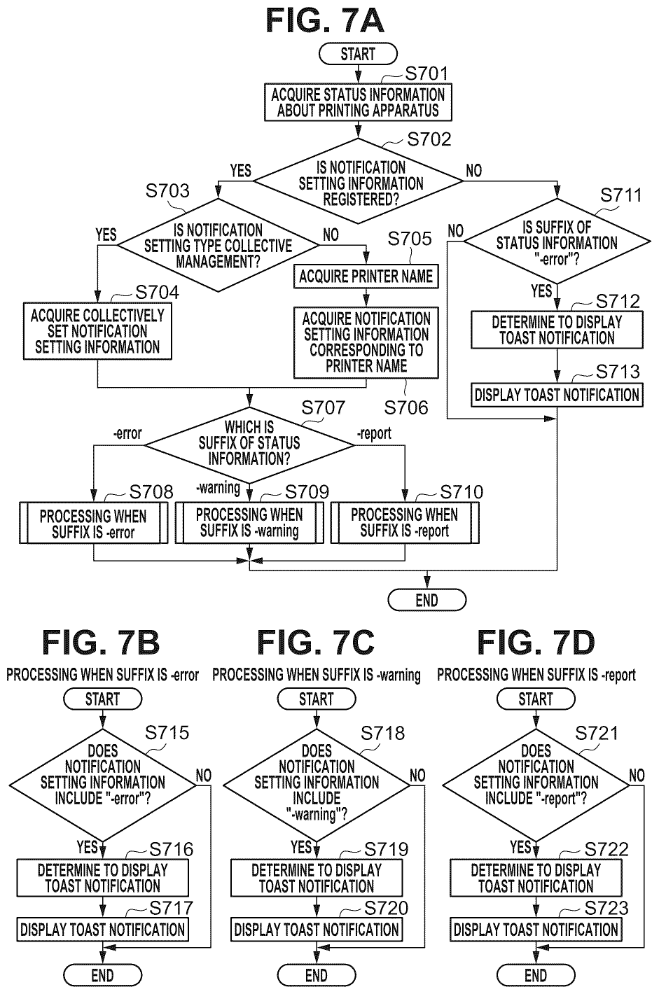

Next, the flowchart of FIG. 7A will be described, in which the OS determines whether to display a toast notification in step S312 of FIG. 3 in response to the status response (status information) received in step S311 based on the registered notification setting information.

In step S701, the OS initially acquires the status information returned from the printing apparatus 102. The processing proceeds to step S702.

In step S702, the OS determines whether notification setting information is registered by the extension application 204. If notification setting information is registered (YES in step S702), the processing proceeds to step S703. If notification setting information is not registered (NO in step S702), the processing proceeds to step S711.

In step S703, the OS determines whether the notification setting information registered by the extension application 204 indicates collective management. Whether the registered notification setting information indicates collective management is determined based on whether the notification setting information is registered along with the registration of the printer name. Alternatively, information indicating collective management may be registered with the notification setting information instead of the printer name.

For example, information indicating that the notification setting information is applied to all printers, such as “ALL”, or information indicating that no printer name is registered, such as NULL, may be registered in the OS with the notification setting information instead of the printer name.

If the notification setting information indicates collective management (YES in step S703), the processing proceeds to step S704. In step S704, the OS acquires the collectively set notification setting information. The processing proceeds to step S707.

If the notification setting information indicates printer-by-printer management (NO in step S703), the processing proceeds to step S705. In step S705, the OS acquires the printer name of the printing apparatus 102. The printer name of the printing apparatus 102 may be acquired from the attribute value in the response that can be acquired by issuing an IPP Get-Printer-Attributes operation, or from the HWID associated with the specified print queue.

After the OS acquires the printer name in step S705, the processing proceeds to step S706. In step S706, the OS acquires the notification setting information corresponding to the printer name acquired in step S705. The processing proceeds to step S707.

In step S707, the OS determines which the suffix of the status information acquired from the printing apparatus 102 is, “-error”, “-warning”, or “-report”. The processing proceeds to step S708, S709, or S710 depending on the type of suffix. Specifically, if the suffix is “-error” (-error in step S707), the processing proceeds to step S708. If the suffix is “-warning” (-warning in step S707), the processing proceeds to step S709. If the suffix is “-report” (-report in step S707), the processing proceeds to step S710.

Details of the processing of steps S708, S709, and S710 will be described with reference to FIGS. 7B, 7C, and 7D, respectively.

FIG. 7B is a flowchart illustrating details of the processing of step S708. In step S715, the OS initially determines whether the notification setting information registered therein, acquired in step S704 or S706 of FIG. 7A, includes “-error”. If the notification setting information includes “-error” (YES in step S715), the processing proceeds to step S716.

In step S716, the OS determines to display a toast notification. In step S717, the OS displays the toast notification.

On the other hand, if the notification setting information does not include “-error” (NO in step S715), the processing ends.

Next, details of the processing of step S709 will be described with reference to FIG. 7C. In step S718, the OS initially determines whether the notification setting information registered therein includes “-warning”. If the notification setting information includes “-warning” (YES in step S718), the processing proceeds to step S719.

In step S719, the OS determines to display a toast notification.

In step S720, the OS displays the toast notification. On the other hand, if the notification setting information does not include “-warning” (NO in step S718), the OS determines that a toast notification does not need to be displayed, and the processing ends.

Finally, details of the processing of step S710 will be described with reference to FIG. 7D.

In step S721, the OS initially determines whether the notification setting information registered therein includes “-report”. If the notification setting information includes “-report” (YES in step S721), the processing proceeds to step S722. In step S722, the OS determines to display a toast notification. In step S723, the OS displays the toast notification. On the other hand, if the notification setting information does not include “-report” (NO in step S721), the OS determines that a toast notification does not need to be displayed, and the processing ends.

The above is an example of the processing by the OS in the case where notification setting information is registered in the OS. Returning to FIG. 7A, the processing in the case where notification setting information is not registered in the OS will now be described. If notification setting information is determined to not be registered (NO in step S702), the processing proceeds to step S711. In the case where notification setting information is determined to not be registered, the OS performs processing based on a predetermined notification setting condition.

In step S711, the OS checks whether the suffix of the status information acquired from the printing apparatus 102 is “-error”. If the suffix of the status information is “-error” (YES in step S711), the processing proceeds to step S712. In step S712, the OS determines to display a toast notification. In step S713, the OS displays the toast notification. If the suffix of the status information is not “-error” (NO in step S711), the OS determines that notification does not need to be displayed, since the predetermined notification setting condition only covers the case where the suffix of the status notification is “-error”, and the processing ends.

In printing using the standard print specifications, the toast notification related to the state of the printing apparatus 102 is usually displayed based on the predetermined notification condition. By contrast, according to the present exemplary embodiment, the user can set the notification setting by himself/herself to control the notification condition.

This enables the user to freely change the notification setting and receive notifications even in a case where the user does not want to display notifications when the printing apparatus 102 is printing or where the user wants to receive notifications even in the event of warnings during printing.

A second exemplary embodiment will be described. In the foregoing first exemplary embodiment, the user registers notification setting information based on a desired notification setting in the OS via the extension application 204, and can thereby control the condition to display a toast notification. However, in a company or organization, there may be cases where the notification settings of the users within the company or organization are desirably managed under the same conditions. In such a case, it is desirable that the administrator in the company or organization can collectively set the notification settings of the users within the company or organization.

The present exemplary embodiment describes an example where the administrator in the company or organization registers notification setting information in the OSs of the host computers within the company or organization using the extension application 204.

In the following description, the extension application 204 may be described as the agent of the processes. In fact, corresponding functions are implemented by the CPU 111 executing the corresponding programs.

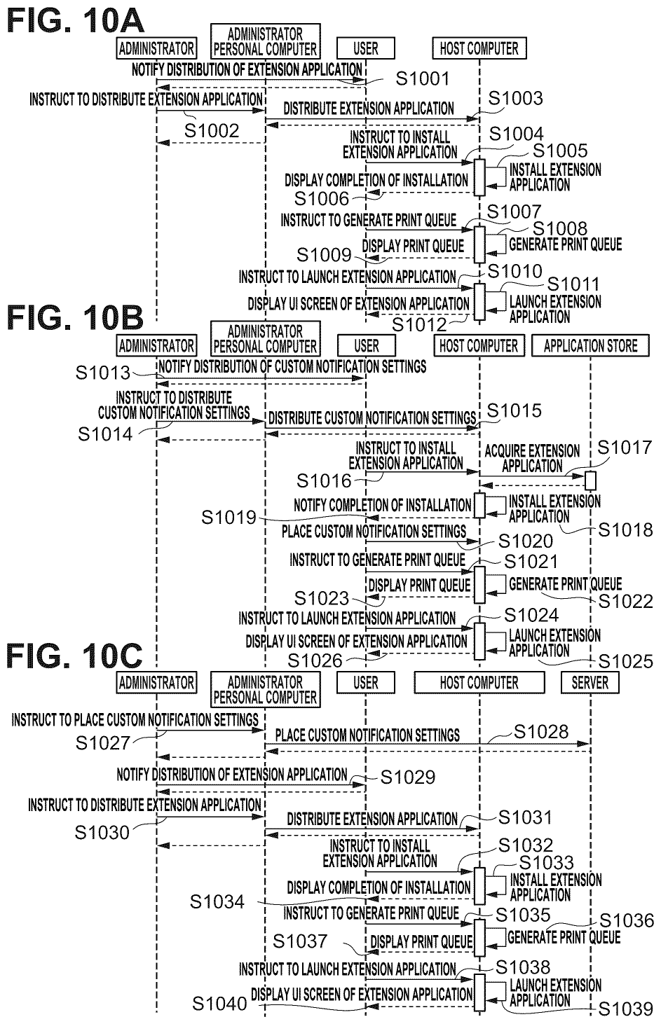

A processing procedure will initially be described with reference to FIGS. 10A to 10C, where the administrator in the company or organization creates “custom notification settings” for the company or organization and distributes the custom notification settings to users within the company or organization, and the users launch their extension application 204. The content of the notification settings configured by the custom notification settings is similar to that of the notification settings described in the foregoing first exemplary embodiment (for example, FIG. 5). In the present exemplary embodiment, the notification settings will be referred as “custom notification settings” for the sake of distinction from the notification settings configured by the users themselves.

There can be more than one method for the administrator to distribute the custom notification settings to the users. In the present exemplary embodiment, the methods will therefore be described with reference to FIGS. 10A to 10C separately.

FIG. 10A is a sequence diagram for a case where the custom notification settings are included in the extension application 204 itself. In the case of FIG. 10A, to accommodate the custom notification settings to be implemented in the target company or organization, the extension application 204 is desirably modified in a dedicated manner and provided to the administrator in the company or organization.

In step S1001, the administrator in the company or organization receiving the dedicatedly configured extension application 204 notifies the users of the distribution of the extension application 204. Specifically, the administrator can post a message about the distribution of the extension application 204 on the company or organization's internal website. Alternatively, the administrator may notify the users of the distribution of the extension application 204 through verbal communication, email, or other communication tools.

In distributing the dedicatedly configured extension application 204, the extension application 204 is distributed with setup information for associating the extension application 204 with print data generation software. In the present exemplary embodiment, the setup information refers to a file with an extension .inf, called an extended INF file. However, other file formats may be used.

In step S1002, the administrator instructs an administrator personal computer to distribute the extension application 204. In step S1003, the administrator personal computer distributes the extension application 204 to the host computers 101 within the company or organization.

As a method for distributing the extension application 204 from the administrator personal computer, the administrator may distribute the extension application 204 from the administrator personal computer to the host computers 101 by email. Alternatively, the administrator may access a server shared in the company or organization from the administrator personal computer and place the extension application 204, and user personal computers may acquire the extension application 204 from the server. Similarly, the extension application 204 may be distributed using a cloud storage service shared in the company or organization. The administrator may distribute the extension application 204 to the host computers 101 managed within the company or organization via the administrator personal computer, using a client personal computer management tool.

A configuration of the printing system using the client personal computer management tool will now be described with reference to FIG. 1B.

FIG. 1B is a schematic diagram illustrating the printing system in the company or organization where the client personal computer management tool is introduced. In this printing system, a management server 121 for performing client management, an administrator personal computer 122, a client personal computer (A) 123, and a client personal computer (B) 124 are communicably connected via a network. The client personal computer (A) 123 and the client personal computer (B) 124 are computers having a hardware configuration similar to that of the host computer 101.

The administrator who uses the administrator personal computer 122 can manage the configurations of the client personal computer (A) 123 and the client personal computer (B) 124, and manage and distribute software. In the present exemplary embodiment, the client personal computer management tool is installed on the client personal computer (A) 123 and the client personal computer (B) 124. This enables the administrator to distribute the extension application 204 and files describing the custom notification settings.

Return to the description of FIG. 10A. As described above, in step S1003, the administrator distributes the extension application 204 including the custom notification settings to the users. The processing proceeds to step S1004.

In step S1004, each user in the company or organization instructs his/her own host computer 101 to install the extension application 204.

In step S1005, the host computer 101 installs the extension application 204. Here, the host computer 101 also installs the extended INF file that is the setup information about the extension application 204 at the same time. After the installation is completed, in step S1006, the host computer 101 displays the completion of the installation on the display unit 119 for user notification.

In step S1007, the user in the company or organization instructs the host computer 101 to generate a print queue. In step S1008, receiving the user's instruction, the host computer 101 generates a print queue. Here, the host computer 101 associates the extension application 204 installed in step S1005 with the print queue.

In step S1009, the host computer 101 displays the generated print queue to the user via the display unit 119. In step S1010, the user in the company or organization instructs the host computer 101 to launch the installed extension application 204. In step S1011, the host computer 101 launches the extension application 204.

In step S1012, the host computer 101 displays the UI screen of the extension application 204 on the display unit 119. The print function extension unit 207 checks the presence or absence of the custom notification settings and registers the notification setting information in the OS between when the extension application 204 is launched in step S1011 and when the extension application 204 displays the UI screen on the display unit 119 in step S1012. Details of the processing will be described below.

FIG. 10B is a sequence diagram for a case where the custom notification settings are not included in the extension application 204, and the extension application 204 is separately placed in an accessible area.

In FIG. 10B, the extension application 204 itself does not include the information. The custom notification settings can thus be relatively easily modified compared to the case of FIG. 10A. Since there may be cases where the administrator in the company or organization subsequently wants to modify the once registered custom notification settings after the start of operation, the method of FIG. 10B is considered to be favorable in view of flexible operation compared to the method of FIG. 10A. In such a case, the extension application 204 does not need to be one modified for the company or organization in advance.

In step S1013, the administrator initially notifies the users of the distribution of the custom notification settings. Specifically, the distribution can be notified by a method similar to that of step S1001. Specific examples may include the administrator in the company or organization posting a message indicating the distribution of the custom notification settings on the company or organization's internal website, and notifying the users of the distribution of the custom notification settings through verbal communication, email, or other communication tools.

The administrator creates the custom notification settings. The content of the custom notification settings includes the foregoing notification setting type and notification settings, and the information can be described in any format. Specific examples include ini, XML, JavaScript Object Notation (JSON), YAML Ain't Markup Language (YAML), Tom's Obvious, Minimal Language (TOML), and Property List (PLIST) formats. The host computers' registries may be edited.

In step S1014, the administrator instructs the administrator personal computer to distribute the custom notification settings.

In step S1015, the administrator personal computer distributes the custom notification settings to the host computers 101 within the company or organization.

As a method for providing the custom notification settings, the administrator personal computer may distribute the custom notification settings to the users' host computers 101 by email as described above. Alternatively, the administrator may place the custom notification settings on a server shared within the company or organization, and the users may acquire the custom notification settings from the server. Similarly, the custom notification settings may be distributed using a cloud storage service shared within the company or organization. Alternatively, the administrator may distribute the custom notification settings to the host computers 101 managed within the company or organization via the administrator personal computer, using an endpoint management tool.

In step S1016, each user in the company or organization instructs his/her host computer 101 to install the extension application 204. In step S1017, the host computer 101 requests an application download service (hereinafter, referred to as an application store) provided by Microsoft to acquire the extension application 204, and downloads the extension application 204. While in the present exemplary embodiment the extension application 204 is described to be acquired from the service provided by Microsoft, the extension application 204 may be acquired from other application download services or other websites.

In step S1018, the host computer 101 installs the extension application 204 acquired from the application store. In step S1019, the host computer 101 notifies the user that the installation of the extension application 204 is completed.

In step S1020, the user places the distributed custom notification settings in a predetermined information storage area of the host computer 101. The predetermined information storage area is an area generated by the OS when the extension application 204 is installed on the host computer 101.

In the present exemplary embodiment, a method where the user places the custom notification settings distributed in advance in the predetermined information storage area has been described. However, the custom notification settings may be placed by the administrator instead of the user. Specifically, the administrator can access the foregoing endpoint management tool from the administrator personal computer and distribute the custom notification settings to the predetermined storage areas of the host computers 101 under management. The distribution of the custom notification settings by the administrator can be said to be more desirable since the application of the custom notification settings is not committed to each user's operation.

In step S1021, the user in the company or organization instructs the host computer 101 to generate a print queue. In step S1022, receiving the user's instruction, the host computer 101 generates a print queue. Here, the host computer 101 associates the extension application 204 installed in step S1018 with the print queue. In step S1023, the host computer 101 displays the generated print queue to the user via the display unit 119.

In the present exemplary embodiment, the custom notification settings are assumed to be placed in the predetermined information storage area in step S1020 before the print queue generation processing of steps S1021 to S1023. However, the custom notification settings may be placed in the predetermined information storage area after the print queue generation processing. In other words, the placement of the custom notification settings in the predetermined information storage area in step S1020 can be performed at any timing after the completion of installation of the extension application in step S1019 and before the launch instruction for the extension application 204 in step S1024.

In step S1024, the user instructs the host computer 101 to launch the extension application 204. In step S1025, the host computer 101 launches the extension application 204. In step S1026, the host computer 101 displays the UI screen of the extension application 204 on the display unit 119. The print function extension unit 207 checks the presence or absence of the custom notification settings and registers the notification setting information in the OS between when the extension application 204 is launched in step S1025 and when the extension application 204 displays the UI screen on the display unit 119 in step S1026. Details of the processing will be described below.

Finally, FIG. 10C is a sequence diagram for a case where the administrator does not directly distribute the custom notification settings to the users within the company or organization but places the custom notification settings on a separately prepared external server.

In such a case, the information about the server to be accessed at each target company or organization is desirably stored in the extension application 204 in advance. The extension application 204 is therefore modified as an application dedicated to the company or organization where the extension application 204 is used, and provided to the administrator in the company or organization.

That the extension application 204 is modified in a dedicated manner for the company or organization is the same as with FIG. 10A. However, in the case of FIG. 10C, the custom notification settings are not included in the extension application 204 itself but placed on the server. If the custom notification settings are modified, only the information about the server can therefore be changed without modifying the extension application 204.

Unlike FIG. 10B, there is no need to distribute the custom notification settings to the users when changes are made. This is expected to help prevent unintended issues occurring from distribution omissions or mistakes.

In FIG. 10C, in step S1027, the administrator initially instructs the administrator personal computer to place the created custom notification settings on a predetermined server.

In step S1028, the administrator personal computer places the custom notification settings on the predetermined server. The processing proceeds to step S1029. In step S1029, the administrator notifies the users within the company or organization of the distribution of the extension application 204 including the information for accessing the server. Specifically, like step S1001, the administrator in the company or organization may post a message indicating the distribution of the extension application 204 on the company or organization's internal website. Alternatively, the administrator may notify the users of the distribution of the extension application 204 through verbal communication, email, or other communication tools.

In step S1030, the administrator then instructs the administrator personal computer to distribute the extension application 204. In step S1031, the administrator personal computer receiving the administrator's distribution instruction for the extension application 204 distributes the extension application 204 to the users' host computers. The distribution method is similar to that of the extension application 204 in FIG. 10A.

In step S1032, each user in the company or organization instructs his/her own host computer 101 to install the extension application 204. In step S1033, the host computer 101 installs the extension application 204. Here, the host computer 101 also installs the extended INF file that is the setup information about the extension application 204 at the same time. After the installation is completed, in step S1034, the host computer 101 displays the completion of the installation on the display unit 119 for user notification.

In step S1035, the user in the company or organization instructs the host computer 101 to generate a print queue. In step S1036, receiving the user instruction, the host computer 101 generates a print queue. Here, the host computer 101 associates the extension application 204 installed in step S1033 with the print queue. In step S1037, the host computer 101 displays the generated print queue to the user via the display unit 119.

In step S1038, the user in the company or organization instructs his/her own host computer 101 to launch the installed extension application 204. In step S1039, the host computer 101 launches the extension application 204. In step S1040, the host computer 101 displays the UI screen of the extension application 204 on the display unit 119.

The print function extension unit 207 checks the presence or absence of the custom notification settings and registers the notification setting information in the OS between when the extension application 204 is launched in step S1039 and when the extension application 204 displays the UI screen on the display unit 119 in step S1040. Details of the processing will be described below.

In FIG. 10B described in the present exemplary embodiment, the user is assumed to positively acquire the extension application 204 from the application store. However, the extension application 204 may be automatically installed on the host computer 101.

For example, the extension application 204 may be automatically downloaded from the application store to the host computer 101 and installed on the host computer 101 at timing when the host computer 101 is connected to the printing apparatus 102, i.e., simultaneously with the instruction to generate the print queue. Alternatively, the administrator may distribute the extension application 204 to the host computer 101 so that the extension application 204 is automatically installed, using the foregoing endpoint management tool.

If the extension application 204 is automatically installed in FIG. 10B, the administrator may distribute the custom notification settings after the installation of the extension application 204 using the foregoing endpoint management tool. In such a case, the user's instruction to place the custom notification settings in a predetermined information storage area in step S1020 is not needed. The user can use the functions of the extension application 204 by connecting the host computer 101 and the printing apparatus 102, without using the application store. This can be said to provide even higher convenience.

The above is the sequences for the cases where the administrator in the company or organization creates the custom notification settings and distributes the custom notification settings to the users within the company or organization.

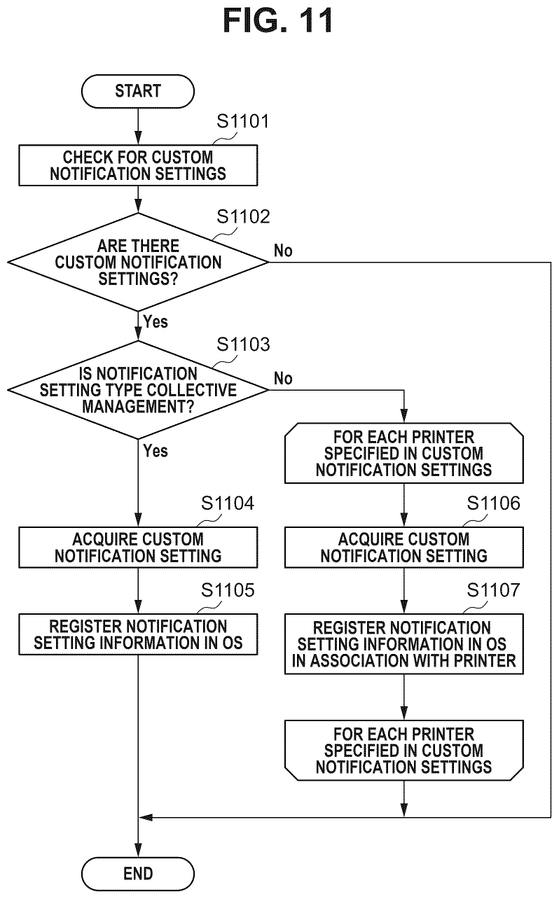

Details of the processing when the print function extension unit 207 checks the presence or absence of the custom notification settings and registers the notification setting information in the OS after the installation and launch of the extension application 204 in the foregoing FIG. 10A, 10B, or 10C will be described with reference to FIG. 11.

In the present exemplary embodiment, the print function extension unit 207 is assumed to simultaneously register the notification setting information based on the custom notification settings at timing when editing the print function information 203 after the installation of the extension application 204. However, the processing for registering the notification setting information may be performed by other units. Alternatively, at timing when the extension application 204 is installed, the OS may activate one of the units of the extension application 204 and the unit may register the notification setting information.

In step S1101 of FIG. 11, the print function extension unit 207 initially checks for custom notification settings. In FIG. 10A, the print function extension unit 207 checks for the custom notification settings registered in the extension application 204 itself in advance. In FIG. 10B, the print function extension unit 207 checks for the custom notification settings placed in the predetermined information storage area of the host computer 101. In FIG. 10C, the print function extension unit 207 checks for the custom notification settings placed on the server by the administrator in the company or organization.

In step S1102, the print function extension unit 207 determines whether there are custom notification settings. If there are custom notification settings (YES in step S1102), the processing proceeds to step S1103. If there are determined to be no custom notification settings (NO in step S1102), the processing of FIG. 11 ends.

In step S1103, the print function extension unit 207 determines whether the notification setting type is collective management or printer-by-printer management, based on the content of the custom notification settings. If the notification setting type is collective management (YES in step S1103), the processing proceeds to step S1104. The processing in a case where the notification setting type is printer-by-printer management (NO in step S1103) will be described below.

In step S1104, the print function extension unit 207 acquires the custom notification setting. If the custom notification setting is included in the extension application 204 in advance, the print function extension unit 207 acquires the included custom notification settings. If the custom notification setting is placed in the predetermined information storage area or on the server, the print function extension unit 207 acquires the placed custom notification setting.

Once the custom notification setting is acquired, the processing proceeds to step S1105. In step S1105, the print function extension unit 207 registers the notification setting information in the OS based on the custom notification setting. Details of the processing by which the print function extension unit 207 registers the notification setting information in the OS based on the custom notification setting are similar to the processing described with reference to FIG. 6 in the first exemplary embodiment. A description thereof will thus be omitted.

If the notification setting type is printer-by-printer management (NO in step S1103), the processing proceeds to step S1106. The print function extension unit 207 performs the processing of steps S1106 and S1107 on each printer specified in the custom notification settings.

Specifically, in step S1106, the print function extension unit 207 acquires the printer-by-printer custom notification settings. The printer-by-printer custom notification settings are information corresponding to the table 501 described above with reference to FIG. 5.

In step S1107, the print function extension unit 207 registers the notification setting information based on the custom notification setting in association with the printer. The processing of step S1107 is also similar to the processing described with reference to FIG. 6 in the first exemplary embodiment. A description thereof will thus be omitted.

According to the foregoing second exemplary embodiment, the administrator in the company or organization can configure given custom notification settings for the users and collectively control the notification conditions for the users within the company or organization.

A third exemplary embodiment will be described. The first and second exemplary embodiments have described the methods by which the user or the administrator in the company or organization registers the notification setting information based on a desired notification setting in the OS via the extension application 204 and controls the display condition for the OS's toast notification. If the notification setting is “disable notifications”, the host computer 101 does not display a toast notification even in a case where an error so severe that the printing apparatus 102 is unable to perform printing occurs and the status information is transmitted to the host computer 101.

If the printing apparatus 102 is located physically close to the user, the user may notice the error occurring on the printing apparatus 102. However, if the printing apparatus 102 is located physically far from the user, it is considered to take long for the user to address the error occurring on the printing apparatus 102 since no toast notification is displayed on the host computer 101. In such a case, the usability can deteriorate despite the desired notification setting registered by the user or the administrator in the company or organization.

The present exemplary embodiment provides a mechanism for displaying a guide to the user and changing the notification setting “disable notifications” when printing is performed a predetermined number of times after the notification setting is configured and the extension application 204 registers the notification setting information in the OS based on the notification setting. This enables the user to change the notification setting.

The processing of the present exemplary embodiment is started by the print data editing unit 208 of the extension application 204 being activated by the OS after the user or the administrator in the company or organization once configures the notification setting and the notification setting information is registered in the OS. The configuration of the notification setting by the user or the administrator in the company or organization and the registration of the notification setting information by the extension application 204 are similar to those of the foregoing exemplary embodiments. A description thereof will thus be omitted.

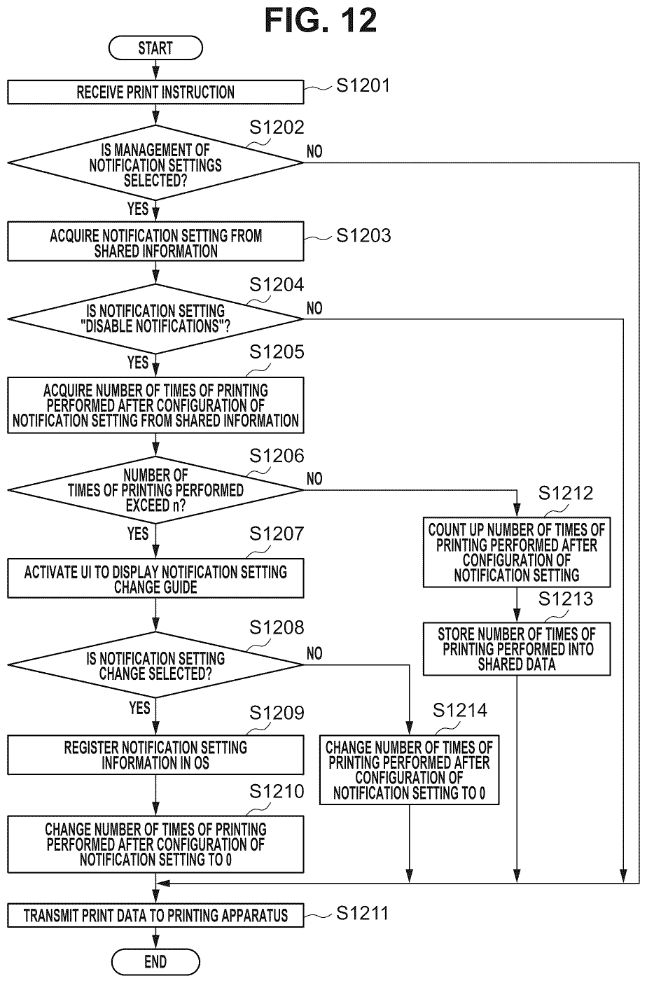

The processing performed by the print data editing unit 208 will be described with reference to FIG. 12.

In step S1201, the print data editing unit 208 is activated by the OS and receives a print instruction. In step S1202, the print data editing unit 208 refers to the information stored in the shared information 210 and checks whether the management of notification settings is selected. If the management of notification settings is selected (YES in step S1202), the processing proceeds to step S1203. If the management of notification settings is not selected (NO in step S1202), the processing proceeds to step S1211. In step S1211, the print data editing unit 208 transmits the print data to the printing apparatus 102. The processing ends.

In step S1203, the print data editing unit 208 acquires the notification setting from the shared information 210. The processing proceeds to step S1204. If the notification setting type is collective management, the print data editing unit 208 acquires the collectively configured notification setting. If the notification setting type is printer-by-printer management, the print data editing unit 208 acquires the print setting related to the target printer activated in association with itself (printer selected as the print destination).

The print data editing unit 208 may acquire information about the target printer from the attribute values that can be acquired from a response acquired by issuing an IPP Get-Printer-Attributes operation. The print data editing unit 208 may determine the printer name from the HWID of the print queue activated in association with itself.

In step S1204, the print data editing unit 208 determines whether the notification setting is “disable notifications”. If the notification setting is “disable notifications” (YES in step S1204), the processing proceeds to step S1205. If the notification setting is not “disable notifications” (NO in step S1204), the processing proceeds to step S1211. In step S1211, the print data editing unit 208 transmits the print data to the printing apparatus 102. The processing ends.

In step S1205, the print data editing unit 208 acquires the number of times of printing performed after the configuration of the notification setting “disable notifications” from the shared information 210. In the present exemplary embodiment, if “disable notification” is set by the notification setting, the print data editing unit 208 of the extension application 204 counts the number of times of printing performed in performing printing after the configuration of the notification setting.

Once the print data editing unit 208 acquires the number of times of printing performed after the configuration of the notification setting from the shared information 210, the processing proceeds to step S1206. In step S1206, the print data editing unit 208 determines whether the number of times of printing performed after the configuration of the notification setting exceeds a predetermined threshold of n for the number of times of printing.

In the present exemplary embodiment, the threshold for the number of times of printing performed, n, is stored in the shared information 210 by the extension application 204 in advance. The threshold for the number of times of printing performed can be freely changed by the user. The user may directly specify the threshold via the print setting screen 401 illustrated in FIG. 4A or the standalone launch screen 404 illustrated in FIG. 4B. Alternatively, information defined in advance in the custom notification settings created by the administrator in the company or organization may be used.

If the number of times of printing performed after the configuration of the notification setting exceeds n (YES in step S1206), the processing proceeds to step S1207. If the number of times of printing performed after the configuration of the notification setting is less than or equal to n (NO in step S1206), the processing proceeds to step S1212.

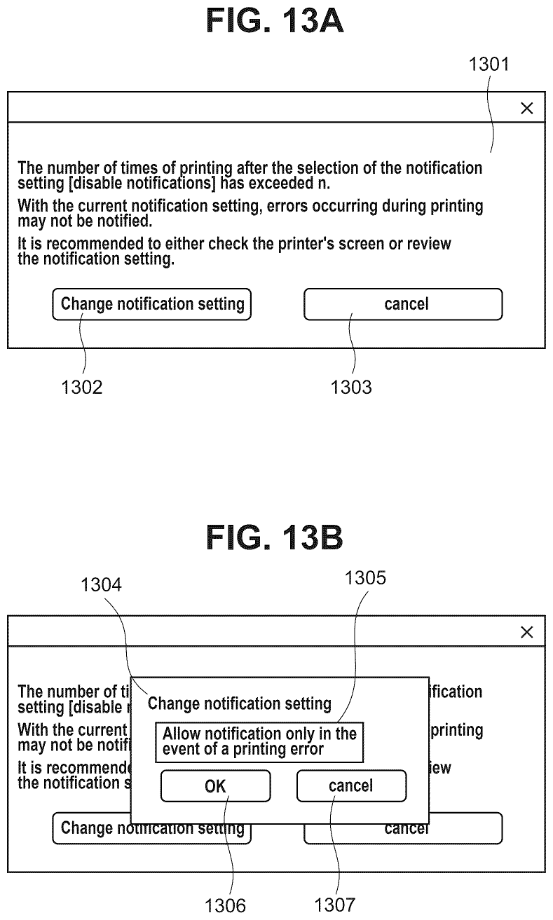

In step S1207, the print data editing unit 208 activates its foreground process, and displays a UI screen on the display unit 119 to display a notification setting change guide illustrated in FIG. 13A to the user.

Guide screens that the print data editing unit 208 displays will be described with reference to FIGS. 13A and 13B. On a notification setting change guide 1301, the print data editing unit 208 provides the following display to the user. The notification setting change guide 1301 displays messages that printing has been performed a certain number of times after the selection of the notification setting “disable notifications”, and that with the current notification setting, errors occurring during printing by the printing apparatus 102 are not notified. The guide screen also provides options for the user as to whether to change the notification setting.

A control 1302 is a control item to be pressed when the user changes the notification setting. A control 1303 is a control item to be pressed when the user simply performs printing without changing the notification setting.

FIG. 13B illustrates a dialog 1304 that is displayed when the control 1302 on the notification setting change guide 1301 is selected.

A control 1305 on the dialog 1304 is a control item that enables the user to select a desired notification setting. Like the options provided by the print setting screen extension unit 205, items such as “allow notification only in the event of a printing error”, “allow notification in the event of a printing error or warning”, “disable notifications”, and “always allow notifications” can be set. The already selected notification setting “disable notifications” may be excluded from the selectable setting items.

A control 1306 is a control item to be pressed when the user applies the setting change after the notification setting is changed on the dialog 1304. On the other hand, a control 1307 is a control item to be pressed when the user discards the change in the notification setting or quits changing the notification setting.

Return to the description of FIG. 12. In step S1207, the print data editing unit 208 displays the notification setting change guide illustrated in FIG. 13A. The processing proceeds to step S1208.

If notification setting change is selected (YES in step S1208), the processing proceeds to step S1209. In step S1209, the print data editing unit 208 registers the notification setting information based on the changed notification setting in the OS. The processing for registering the notification setting information in the OS is similar to the foregoing. A description thereof will thus be omitted.

In step S1210, the print data editing unit 208 changes the number of times of printing performed after the configuration of the notification setting to 0.

In step S1211, the print data editing unit 208 transmits the print data to the printing apparatus 102. The processing ends.

If notification setting change is not selected (NO in step S1208), the processing proceeds to step S1214. In step S1214, the print data editing unit 208 changes the number of times of printing performed after the configuration of the notification setting to 0. Initializing the number of times of printing performed prevents the print data editing unit 208 from continuing displaying the notification setting change guide the next time onward. The notification setting change guide can be displayed to the user again if printing is performed a predetermined number of times again.

After the processing of step S1214, then in step S1211, the print data editing unit 208 transmits the print data to the printing apparatus 102. The processing ends.

In step S1212, the print data editing unit 208 acquires the number of times of printing performed after the configuration of the notification setting from the shared information 210, and counts up the acquired number of times of printing performed.

After the number of times of printing performed is counted up, then in step S1213, the print data editing unit 208 stores the number of times of printing performed that is counted up into the shared information 210 again. In step S1211, the print data editing unit 208 then transmits the print data to the printing apparatus 102. The processing ends.

As described above, according to the third exemplary embodiment, even if the user or the administrator in the company or organization selects “disable notifications” as the notification setting, the notification setting change guide can be displayed to the user at timing when the predetermined number of times of printing performed is reached. This provides the user or the administrator in the company or organization the opportunity to review the notification setting based on the usage after the implementation of the notification setting. This is expected to improve the convenience.

A fourth exemplary embodiment will be described. The third exemplary embodiment has described the processing where, if “disable notifications” is selected as the notification setting, the extension application 204 displays the notification setting change guide, accepts a change in the notification setting by the user, and registers the notification setting information in the OS again. By contrast, enabling a change in the notification setting even if the notification setting selected by the user is other than “disable notifications” enables the user to review the notification setting based on the display frequency of the toast notification. This is expected to improve the user experience.

In the present exemplary embodiment, a method that enables the user to change the notification setting by the extension application 204 displaying a toast notification based on the content of the notification setting instead of the toast notification displayed by the OS will be described.

In the present exemplary embodiment, suppose that the notification setting is already set by the user or the administrator in the company or organization and registered in the OS as notification setting information. The processing of the present exemplary embodiment is started by the OS receiving status information issued from the printing apparatus 102 and activating the print data editing unit 208 of the extension application 204 (in step S314). Since the configuration of the notification setting by the user or the administrator in the company or organization and the registration of the notification setting information in the OS by the extension application 204 are similar to the processing described in the foregoing exemplary embodiments, a description thereof will be omitted.

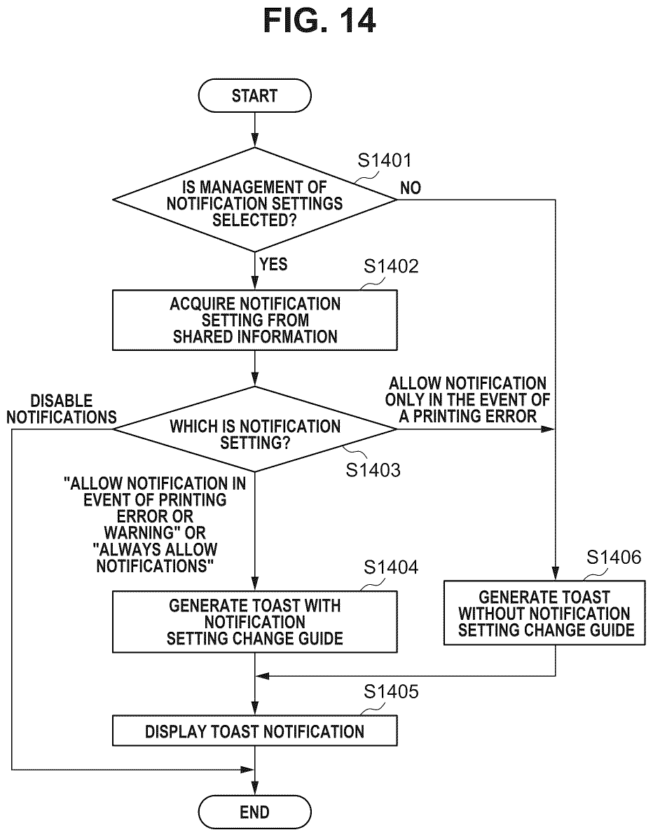

The processing to be performed by the print data editing unit 208 will be described with reference to FIG. 14.

In step S1401, the print data editing unit 208 refers to the shared information 210, and determines whether the management of notification settings is selected. If the management of notification settings is selected (YES in step S1401), the processing proceeds to step S1402. If the management of notification settings is not selected (NO in step S1401), the processing proceeds to step S1406.

In step S1402, the print data editing unit 208 acquires the notification setting from the shared information 210. If the notification setting type is collective management, the print data editing unit 208 acquires the notification setting registered by collective management. If the notification setting type is printer-by-printer management, the print data editing unit 208 acquires the print setting related to the target printer activated in association with itself.

The print data editing unit 208 may acquire information about the target printer from the attribute values that can be acquired from a response to an IPP Get-Printer-Attributes operation. The print data editing unit 208 may determine the printer name from the HWID of the print queue associated with itself.

In step S1403, the print data editing unit 208 determines the notification setting. If, in step S1403, the notification setting is “allow notification in the event of a printing error or warning” or “always allows notifications” (“ALLOW NOTIFICATION IN EVENT OF PRINTING ERROR OR WARDING” OR “ALWAYS ALLOW NOTIFICATIONS in step S1403), the processing proceeds to step S1404. In step S1404, the print data editing unit 208 generates a toast with a notification setting change guide.

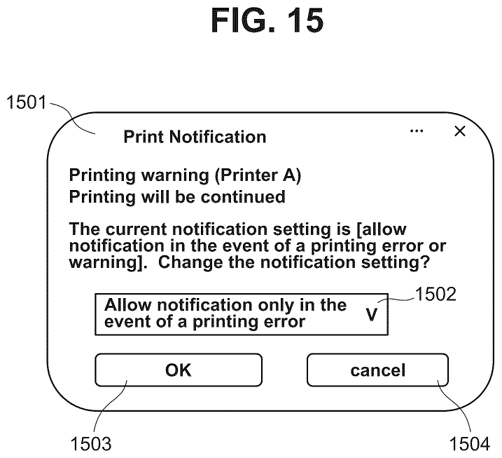

An example of the toast with the notification setting change guide, generated by the print data editing unit 208 will be described with reference to FIG. 15.

FIG. 15 illustrates a toast 1501 with a notification setting change guide, which displays the notification condition set by the notification setting to the user and provides options whether to change the notification setting. A control 1502 of the toast 1501 is a control item that enables the user to select a desired notification setting. Like the options provided by the print setting screen extension unit 205, the control 1502 is capable of setting items such as “allow notification only in the event of a printing error”, “allow notification in the event of a printing error or warning”, “disable notifications”, and “always allow notifications”.

A control 1503 is a control item to be pressed when the user applies the setting change. A control 1504 is a control item to be pressed when the user discards the change in the notification setting or quits changing the notification setting.

In step S1404, the print data editing unit 208 generates the toast with the notification setting change guide illustrated in FIG. 15. The processing proceeds to step S1405.

If the management of notification settings is not selected (NO in step S1401) or if “allow notification only in the event of a printing error” is determined to be selected in step S1403 (ALLOW NOTIFICATION ONLY IN EVENT OF PRINTING ERROR in step S1403), the processing proceeds to step S1406. In step S1406, the print data editing unit 208 generates a toast without a notification setting change guide, i.e., a toast having the same content as that of the toast that the OS notifies the user of.

If the management of notification settings is not selected by the user (NO in step S1401), the toast notification is displayed under the OS's predetermined notification condition. If “allow notification only in the event of a printing error” is selected (ALLOW NOTIFICATION ONLY IN EVENT OF PRINTING ERROR in step S1403), the toast notification is displayed under a condition equivalent to the OS's predetermined notification condition.

In either case, the toast notification is displayed when an error occurs in the printing apparatus 102 and the status information with the suffix “-error” is acquired. Here, the notification condition is set to notify the user of bare minimum information. In the present exemplary embodiment, the notification change guide is therefore not generated. However, the print data editing unit 208 may generate a toast with a notification setting change guide for the user.

In step S1405, the print data editing unit 208 displays the generated toast notification on the display unit 119.

According to the fourth exemplary embodiment, the notification setting can be changed from the toast notification displayed on the display unit 119 after the user or the administrator in the company or organization sets the notification setting information and the notification setting information is registered in the OS.

As described above, according to the foregoing exemplary embodiments, the users and the administrator in the company or organization can appropriately manage the notification frequency of the status information about the printing apparatus 102 by controlling the toast notification setting via the extension application 204. The users and the administrator in the company or organization can thus expect an increase in the use value of the printing system using the OS's standard printing and the extension application 204.

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-005272, which was filed on Jan. 17, 2024 and which is hereby incorporated by reference herein in its entirety.

What is claimed is:

1. A non-transitory computer-readable storage medium storing an application program which causes an information processing apparatus to perform a control method, the control method comprising:
in a case where the application program is launched by a first method, displaying a first control item on a display of the information processing apparatus, the first control item being configured to configure a notification setting related to a state of a printing apparatus serving as an output destination of print data, wherein an operating system (OS) of the information processing apparatus acquires the state of the printing apparatus, and determines whether to issue a notification related to the acquired state of the printing apparatus based on the notification setting configured using the first control item; and
in a case where the application program is launched by a second method, displaying a second control item configured to configure a setting related to print processing of the print data.

2. The non-transitory computer-readable storage medium according to claim 1,
wherein the first method is a method for launching the application program by selecting the application program from an application list that the OS displays on the display, and
wherein the second method is a method for launching the application program via software configured to display an image to be printed.

3. The non-transitory computer-readable storage medium according to claim 1, wherein the notification is issued by the OS.

4. The non-transitory computer-readable storage medium according to claim 1,
wherein the application program is configured to cause the information processing apparatus to register the accepted notification setting in the OS as notification setting information, and
wherein the notification setting information is information about a character string indicating a magnitude of impact on printing by the printing apparatus in a character string indicating information about the state of the printing apparatus.

5. The non-transitory computer-readable storage medium according to claim 1, wherein the notification setting includes a setting to issue the notification only in a case where the printing apparatus is in a state of being unable to continue printing.

6. The non-transitory computer-readable storage medium according to claim 1, wherein the notification setting includes a setting to issue the notification in a case where the printing apparatus is in a state of possibly causing a defect in its print outcome and in a case where the printing apparatus is in a state of being unable to continue printing.

7. The non-transitory computer-readable storage medium according to claim 1, wherein the notification setting includes a setting to issue the notification even in a state where a print outcome of the printing apparatus is not affected.

8. The non-transitory computer-readable storage medium according to claim 1, wherein the notification setting includes a setting to disable notifications.

9. The non-transitory computer-readable storage medium according to claim 8, wherein the application program is configured to, in a case where a number of times of printing performed after the notification setting is configured to disable notifications exceeds a predetermined number of times, display the first control item.

10. The non-transitory computer-readable storage medium according to claim 2,
wherein the application program is launched in response to a user of the information processing apparatus clicking the notification of the state of the printing apparatus issued by the OS, and
wherein the application program is configured to, when the state of the printing apparatus is acquired with the application program running, cause the information processing apparatus to display the first control item.

11. The non-transitory computer-readable storage medium according to claim 2,
wherein the application program is launched in response to a user of the information processing apparatus clicking the notification of the state of the printing apparatus issued by the OS, and
wherein the application program is configured to, when launched, cause the information processing apparatus to display a screen displaying the state of the printing apparatus on the display.

12. The non-transitory computer-readable storage medium according to claim 11, wherein the application program is configured to, when another state of the printing apparatus is acquired, cause the information processing apparatus to update the state of the printing apparatus displayed on the screen.

13. The non-transitory computer-readable storage medium according to claim 1, wherein the notification is a toast notification.

14. The non-transitory computer-readable storage medium according to claim 1, wherein the application program is provided by a vendor of the printing apparatus serving as the output destination of the print data.

15. A control method of an information processing apparatus in which an application program is installed, the control method comprising:
in a case where the application program is launched by a first method, displaying a first control item on a display of the information processing apparatus, the first control item being configured to configure a notification setting related to a state of a printing apparatus serving as an output destination of print data, wherein an OS of the information processing apparatus acquires the state of the printing apparatus, and determines whether to issue a notification related to the acquired state of the printing apparatus based on the notification setting configured using the first control item; and
in a case where the application program is launched by a second method, displaying a second control item configured to configure a setting related to print processing of the print data.

16. The control method according to claim 15,
wherein the first method is a method for launching the application program by selecting the application program from an application list that the OS displays on the display; and
wherein the second method is a method for launching the application program via software configured to display an image to be printed.

17. The control method according to claim 15, wherein the notification is issued by the OS.

18. The control method according to claim 15, further comprising registering the accepted notification setting in the OS as notification setting information,
wherein the notification setting information is information about a character string indicating a magnitude of impact on printing by the printing apparatus in a character string indicating information about the state of the printing apparatus.

19. The control method according to claim 15, wherein the notification setting includes a setting to issue the notification only in a case where the printing apparatus is in a state of being unable to continue printing.

20. The control method according to claim 15, wherein the notification setting includes a setting to issue the notification in a case where the printing apparatus is in a state of possibly causing a defect in its print outcome and in a case where the printing apparatus is in a state of being unable to continue printing.

21. The control method according to claim 15, wherein the notification setting includes a setting to issue the notification even in a state where a print outcome of the printing apparatus is not affected.

22. The control method according to claim 15, wherein the notification setting includes a setting to disable notifications.

23. The control method according to claim 22, wherein in a case where a number of times of printing performed after the notification setting is configured to disable notifications exceeds a predetermined number of times, a screen configured to change the notification setting is displayed.

24. The control method according to claim 16,
wherein the application program is launched in response to a user of the information processing apparatus clicking the notification of the state of the printing apparatus issued by the OS, and
wherein when the state of the printing apparatus is acquired with the application program running, a screen configured to change the notification setting is displayed.

25. The control method according to claim 16,
wherein the application program is launched in response to a user of the information processing apparatus clicking the notification of the state of the printing apparatus issued by the OS, and
wherein when the application program is launched, a screen displaying the state of the printing apparatus is displayed.

26. The control method according to claim 25, wherein when another state of the printing apparatus is acquired, the state of the printing apparatus displayed on the screen is updated.

27. The control method according to claim 15, wherein the notification is a toast notification.

28. The control method according to claim 15, wherein the application program is provided by a vendor of the printing apparatus serving as the output destination of the print data.

29. An information processing apparatus in which an application program is installed, the information processing apparatus comprising:
at least one processor; and
at least one memory that is in communication with the at least one processor, wherein the at least one memory stores instructions for causing the at least one processor and the at least one memory to:
in a case where the application program is launched by a first method, display a first control item on a display of the information processing apparatus, the first control item being configured to configure a notification setting related to a state of a printing apparatus serving as an output destination of print data, wherein an OS of the information processing apparatus acquires the state of the printing apparatus, and determines whether to issue a notification related to the acquired state of the printing apparatus based on the notification setting configured using the first control item; and
in a case where the application program is launched by a second method, display a second control item configured to configure a setting related to print processing of the print data.
